(19) United States
(12) Patent Application Publication
(10) Pub. No.: US 2016/0100551 A1
(43) Pub. Date: Apr. 14, 2016

(54) PORTABLE ANIMAL PAW WASHING DEVICE

(71) Applicant: Douglas Hanneken, Saint Louis, MO (US)

(72) Inventor: Douglas Hanneken, Saint Louis, MO (US)

(21) Appl. No.: 14/879,631

(22) Filed: Oct. 9, 2015

Related U.S. Application Data
(60) Provisional application No. 62/062,452, filed on Oct. 10, 2014.

(51) Int. Cl. A01K 13/00

(52) U.S. Cl. CPC A01K 13/001; A01K 13/003

(57) ABSTRACT

An animal paw washing device is disclosed. The animal paw washing device includes an elongated container with a sidewall, an end wall and an open rim. The open rim is fitted with an elastic squeegee of conical shape. The elongated container is fitted with means to agitate a liquid so as not to require relative movement of the animal paw to the device to facilitate the cleaning action. The preferred method of agitation is an elastomeric bulb that, when squeezed, forces liquid through a series of orifices, creating jets of turbulent liquid directed at the animal's paw and lower leg.

### RELATED APPLICATIONS

This application claims the benefit of priority from and incorporates by reference herein, U.S. Provisional Application No. 62062452, filed Oct. 10, 2014.

### FIELD

The field of the invention relates to cleaning devices for animal paws. More particularly, the present invention relates to improvements to existing portable devices for cleaning of an animal's paws.

### BACKGROUND OF THE INVENTION

Animals' paws often become dirty with mud or dirt during activities out of doors. It is often necessary to clean animals and their paws before allowing them to reenter the home or auto.

Numerous devices have been devised that resemble large tray or pan structures with either manually or electrically operated scrubbing features. In recent times, smaller hand-held devices have been devised that clean one paw or leg at a time. These devices, such as the ones disclosed in U.S. Pat. No. 6,851,391 and U.S. Pat. No. 8,474,408, have been developed to aid in cleaning animal paws. The devices are generally portable in nature and consist of elongated containers that are open on one end with enclosed bottoms to contain a cleaning agent such as water and/or detergent.

These prior art devices require a portion of the container to fit relatively snug to the animal's leg and/or paw. Agitation of either the animal's leg or relative motion of the entire device creates a suction whereby the dirt and debris is pulled from the fur and crevices of the paw. Further, a close fitting flexible collar is often fitted at the entry/exit of the device to either squeegee the dirty cleaning agent from the leg/paw or create a seal to pull the agent via vacuum from the leg/paw during exit. The close fitting collar's actual fitment is dependent on the girth of the animal's leg. Consequently, the ability of the collar to seal well enough to create a vacuum is tenuous given the large variability in size of animal legs.

Further, some devices also employ a mechanical means for scrubbing, washing, and cleaning animals' paws. The scrubbing action is typically accomplished with an internal element such as a bristle brush, abrasive cloth material, or features on the sidewall of the container. The mechanical means for scrubbing is also via agitation of either the animal's leg or relative motion of the entire device to the leg by the user.

The agitation of either the animal's leg or the actual device may prove awkward to the user and uncomfortable to the animal and cause fright. This is especially true if the device contains a scrubbing element. Accordingly, there is a need for an improved portable device for cleaning animal paws that overcomes the limitations of the prior art. More particularly, there is a need for a device that provides robust cleaning of the paw without awkward motions or mechanical scrubbing.

### SUMMARY OF THE INVENTION

The present invention solves the above-described problems. More particularly, the present invention provides a device that produces robust agitation of a cleaning agent liquid or medication whilst maintaining a calm and motionless experience for the animal and user.

The device is broadly comprised of a vessel with an elongated rigid cylindrical sidewall, an end wall, and an open rim. The end wall closes one end of the sidewall such as to allow the device to contain a liquid. Further, an inlet and/or outlet, is provided in the device that allows for the liquid to rapidly enter and exit in such a way as to provide a turbulent cleaning action. Said inlet and outlet may also be one and the same opening. The rim is positioned on the end of the sidewall opposite to the end wall and is sized and configured to receive the paw. The open rim is sized and configured by selecting the internal diameter of the rim based on the size of the paw such that the paw may freely move through the rim and into the device.

The open rim is fitted with an elastic lip. The main purpose of the lip is to contain the liquid when the device is placed horizontally on a surface and to contain splashing liquid during agitation. The lip also contains an accordion shaped elastic entry that aids in squeegeeing excess liquid from the leg and paw upon exit. The lip is configured to impart a comfortable fit to the animal's leg without generation of a seal. The elastic entry is funnel shaped. In the event that the user would manually squeegee cleaning agent from the animal's paw or leg, the funnel shape would facilitate liquid reentry into the device as well as provide a guide for inserting the paw into the device. Alternatively, the elastic lip can be composed of multiple elasticized fabric layers that overlap one over the other such that an opening is realized in center for paw entry. The previously mentioned accordion shape would be in the form of an opening iris as the paw is inserted through the fabric.

A removable lid may be affixed over the entry of the vessel to further contain the liquid for transport. Alternately, the liquid could be contained in the vessel via a plug inserted into either the open rim of the vessel or into the opening of the elastic accordion shape.

In operation, the device is first partially filled with a liquid. The liquid may be a cleaning agent such as water, water with detergent, shampoo, or any other solution suitable for cleaning animal paws. In addition the liquid may be a medication for treating or cleansing a wound on the leg or paw. An animal paw is then inserted through the rim and into the liquid. Once the paw is inserted in the device, the user agitates the liquid via a manual squeeze bulb pump.

The squeezing of the bulb rapidly expels the cleaning liquid from the bulb toward the paw and lower leg of the animal, while the subsequent release draws a portion of the liquid back into the bulb for a repeated cycle. This rapid movement of liquid through and around the crevices of the paw and lower leg creates agitation that aids in dislodging of dirt and debris. To further improve the agitation of the moving liquid, a series of orifices are positioned at the inlet-exit of the pump directly below the paw. As liquid is forced through the orifices, multiple small jets of liquid are created to impinge the crevices of the paw at a higher speed, improving the cleaning action.

When the cleaning action is complete, the user withdraws the paw from the device. As the paw is withdrawn, an elastic squeegee with accordion folds removes the bulk liquid from the leg and surface of the paw. With the paw suspended over the device, the user may choose to further squeegee liquid from the animal's leg and paw manually with their hand. The funnel shaped elastic accordion will direct any squeegeed liquid back into the container.

Once the user removes the paw from the device, he or she disposes of any remaining liquid by dumping the contents of the device into a drain or other receptacle. The device may then be stored without any further attention until its next use.

By constructing the device as described herein, numerous advantages are realized over current portable paw washing devices on the market. The paw and leg can be cleaned without the physical contact of a scrubbing element such as a brush or abrasive cloth. Additionally, the device does not require a close fitment of the paw to the device walls or elastic collar to impart a vacuum. The device does not require awkward user movement of the device or the animal's leg. These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a perspective view of a device for cleaning an animal's paw constructed in accordance with a preferred embodiment of the present invention;

FIG. 2 is a cutaway view of the preferred embodiment of the device;

FIG. 3 is a perspective view of the preferred embodiment of the device configured with a lid in the closed position.

FIG. 4 is a perspective view of the preferred embodiment of the device configured with a lid in the open position.

FIG. 5 is a cutaway view of the preferred embodiment of the device during operational use;

FIG. 6 is a cutaway view of the device resting on a horizontal surface;

FIG. 7 is a cutaway view of another embodiment of the device wherein the inlet/outlet for agitating the liquid is located in the sidewall.

FIG. 8 is a perspective view of another embodiment of the device wherein a drying feature is attached externally to the device.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

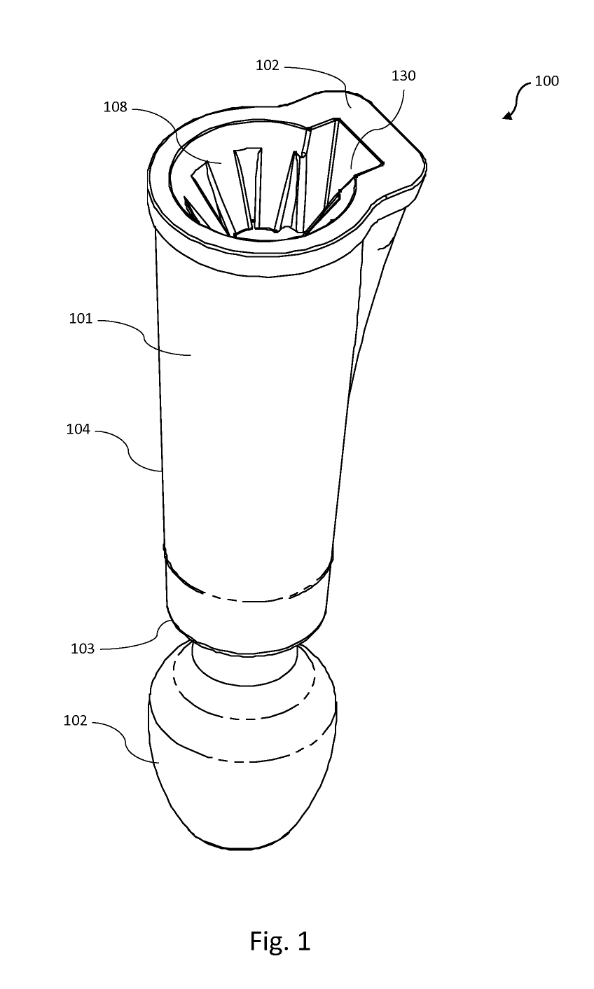

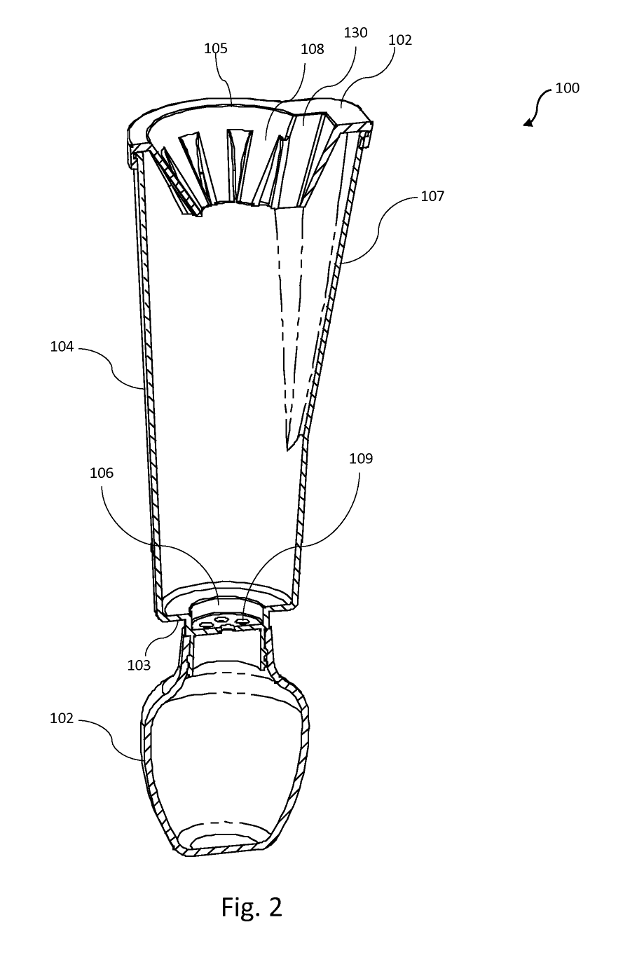

Illustrated in the drawing figures, and particularly FIG. 1 is, a device 100 for cleaning an animal's paw constructed in accordance with a preferred embodiment and broadly comprises an elongated rigid cylindrical sidewall 101, an end wall 103, and an open rim 105. The end wall 103 closes one end of the sidewall 101 such as to allow the device 100 to contain a liquid 113. The rim 105 is positioned on an end of the sidewall 104 opposite to the end wall 103.

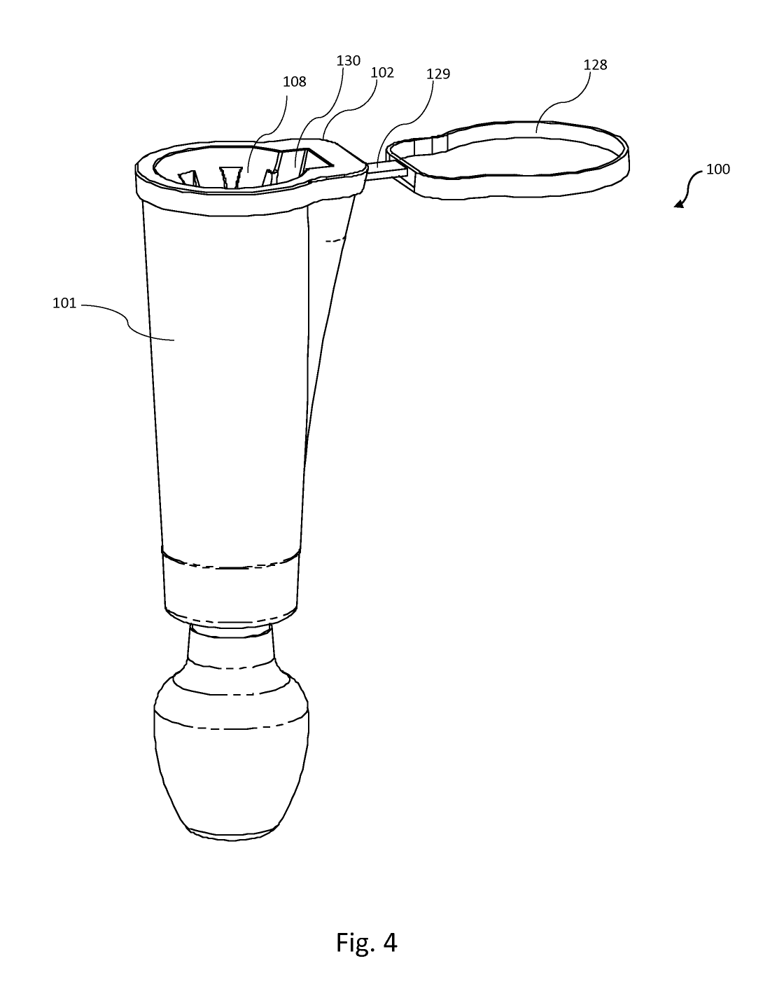

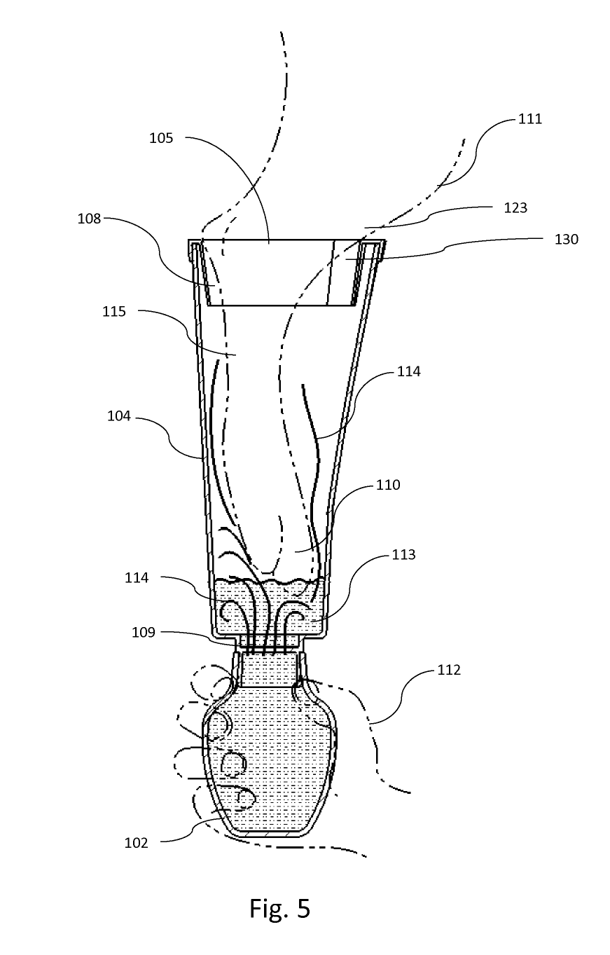

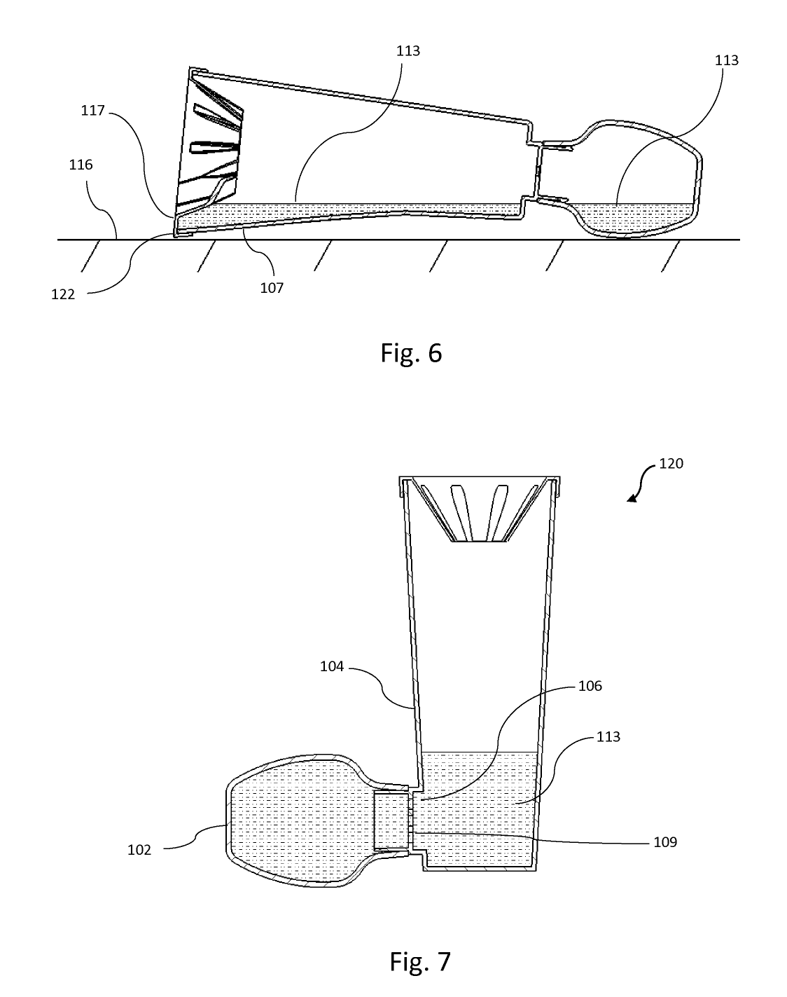

The rim 105 preferably has an elastic cap 102 with integral lip 117 as shown in FIG. 4 to retain splashing liquid 113. The cap 102 contains an elastic squeegee funnel of conical shape 108 with expandable accordion features 121 to guide the paw into the device 100 without catching or snagging. The funnel feature 108 collapses loosely around the animal's leg 115 to prevent splashing of the liquid 113. The rim 105 is sized and configured by having an internal diameter selected based on the size of the paw such that the paw may freely move through the rim 105 and into the device 100. The funnel feature 121 has the additional benefit of guiding any dripping liquid from the animal's paw 110 immediately after removal from the device 110. FIG. 6 depicts the rim lip 117 of the elastic cap 102 retaining liquid 113 while resting horizontally on a surface 116.

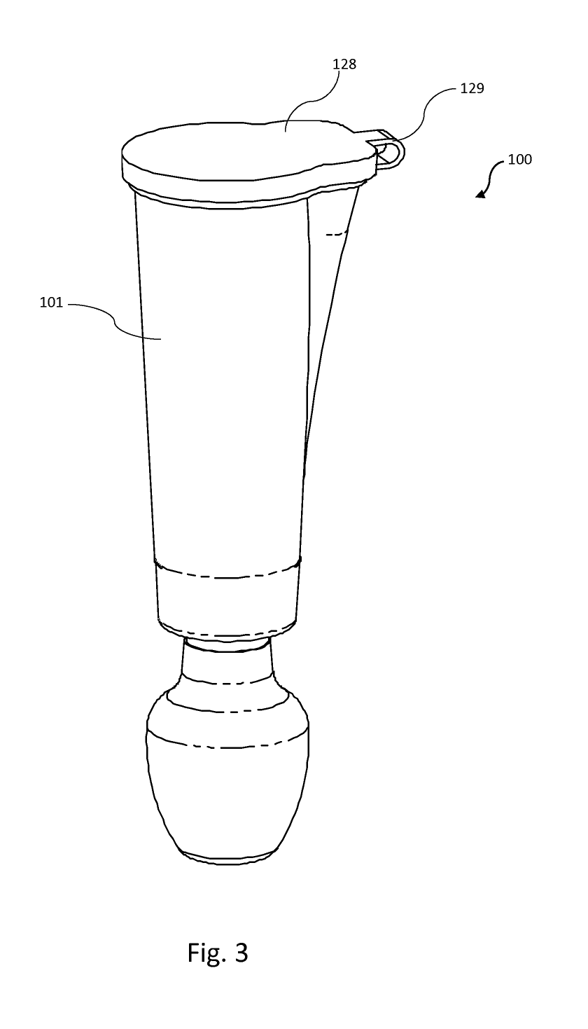

FIGS. 3 and 4 illustrate the elastic cap 102 adapted to receive a closable lid 128 to retain liquid within the device. The lid 128 has a tether 129 connecting it to the device 100. It is within the scope of the invention that the tether can be permanently attached to device 100, or alternatively, detachable from device 100, or omitted completely. It is further envisioned that the rim 105 can be configured to receive the closable lid 128 with or without elastic cap 102 installed in device 100.

The side wall 104 preferably contains an elongated feature 107 near the open rim 105. The elongated feature 107 accommodates the widened portion of the animal's leg 123 near the open rim 105. The feature 107 has a substantially flat edge 122 for contact with a surface 116. The flat edge 107 prevents device 100 from rolling when at rest on a horizontal surface. Likewise, the funnel feature 108 has additional geometry to form an area of relief 130 over feature 107 so as to accommodate the widened portion of the animal's leg 123. The preferred embodiment has the sidewall 104 substantially round. Alternatively, the sidewall 104 could be constructed of multiple flat sides to accommodate the widening leg 123 whilst eliminating the possibility of rolling of the device 100. Further, it is envisioned that the side wall 104 could also have an elliptical shape that might negate the need for the elongated feature 107 and is considered within the scope of the invention.

The end wall 103 is configured with a port 106 for inlet and outlet of a liquid 113. Attached to the port 106 is a bulb 102 that is used as both a handle and a pump by the user 112. The bulb 102, when squeezed would expel liquid through the port 106 and surround the paw and leg of the animal. When the bulb 102 is un-squeezed, the liquid is withdrawn back through the port into the bulb interior once again. The port 106 preferably contains a plurality of orifices 109 to impart turbulence in the liquid flow 114 produced by the rapid squeezing of bulb 102. The turbulent flow 114 around the paw 110 is desirable for thorough cleaning of dirt and debris from said paw and lower leg 115. The effect of turbulent flow for cleaning is akin to an agitator in a clothes washer. Other features may be employed in addition to, or instead of, the orifices 109 to increase agitation turbulence of liquid flow 114.

An alternative embodiment 120 is illustrated in FIG. 7 in which the port 106 is located in the sidewall 104 of the device 100. The port 106 preferably would impart turbulent flow through features such as the orifices 109.

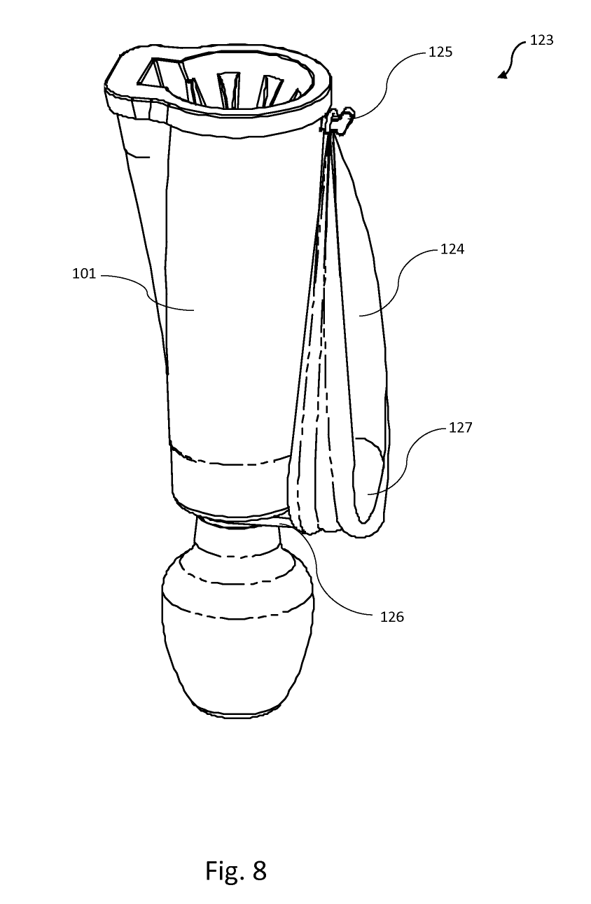

An alternative embodiment is illustrated in FIG. 8 in which a device 100 is fitted with a drying feature 124. The drying feature 124 shown is an absorbent material such as cloth with an attachment point 125 near the device opening and a band 126 around the lower end of the device. The drying feature 124 forms a pocket 127 which would receive the animal paw for drying after washing. The drying feature is attached on device 100 in such a location as to be conveniently used immediately after washing so as to limit the mess of a wet or dripping paw on the user's floor. Alternatively, the drying feature could be a simple absorbent cloth similar to a golfer's towel with at least one attachment point to the device 100. Further still, the drying feature 124 could be housed in a separate compartment similar to the elongated container 101.

The embodiments previously described are not exhaustive in respect to the various ways in which the liquid 113 can be agitated. Numerous methods can be employed to pump, propel or otherwise agitate the liquid. Some common methods that could be used but are not limited to: bellows, pistons, electric pumps, propellers, pneumatic pumps or forcing air through the liquid. As an alternative to a rigid sidewall 104 or end wall 103, said walls could be flexible, all or in part, in such a way as to be compressed by the user to impart agitation to the liquid contained therein. It is also possible for the port 106 to be located in any number of locations, including on or near the rim opening 105. All methods of agitating the liquid are considered within the scope of this invention.

The sidewall 104 and end wall 103 may be constructed of any material that is capable of retaining a liquid, including a wide variety of plastics, metals, glass, or other common and inexpensive materials. Ideally, the material is transparent so as to monitor the cleaning process for completion.

It is further envisioned that the device 100 may include multiple chambers which may include the same or fewer of the features described above for the purpose of providing multiple stages of cleaning or rinsing. The benefit of multiple stages being that the user would not have to stop, empty and refill a single chamber device for another stage of cleaning

In operation, the device 100 is partially filled with the liquid 113. The liquid 113 may be a cleaning solution, water, water with detergent, shampoo, or any other liquid suitable for washing or acting as a medication for the paw. The user then inserts the animal's paw through the rim 105 and into proximity of the liquid 113 near the end wall 103. Once the animal's paw is inserted in the device 100, the user agitates the liquid 113 via the bulb 102 with repeated squeezing and releases.

After the paw is sufficiently cleaned, the user withdraws the paw from the device 100. As the paw is withdrawn from the device 100, the elastic squeegee 108 with expandable accordion features 121 squeegees excess water from the leg and paw. The user may choose to manually squeegee any remaining water from the paw while maintaining the device 100 near the paw and allowing remaining liquid draining from the paw to be guided back into the device 100 via the conical funnel 108. The device 100 may then be moved to another paw for use or lid 102 removed and the device emptied of remaining liquid and refilled with clean liquid or stored later use.

Although the invention has been described with reference to the preferred embodiment illustrated in the attached drawing figures, it is noted that equivalents may be employed and substitutions may be made herein without departing from the scope of the invention as recited in the claims.

What is claimed is:

1. A device for cleaning an animal's paw, comprising:
An elongated container adapted to retain a liquid, having a sidewall with an open upper end; and
an enclosed lower end; and
an agitation means to produce flow of said liquid.

2. The device of claim 1, wherein the said open upper end is configured with an entry point for an animal's paw comprising a lip for retaining the liquid during use and at rest in a substantially horizontal position.

3. The device of claim 2, wherein the said entry point is adapted to receive a one piece elastic squeegee extending radially inward having a central aperture; and said substantially covering the opening of said container.

4. The device of claim 3, wherein the said elastic squeegee is substantially conical in shape.

5. The device of claim 2, wherein the said entry point is adapted to receive an elastic squeegee that substantially covers the opening of said container.

6. The device of claim 5, wherein the said elastic squeegee has accordion folds.

7. The device of claim 6, wherein the said accordion folds extend axially inward forming a conical shape.

8. The device of claim 1, wherein the device contains a feature to convert the output flow of the said agitation means to at least one fluid jet.

9. The device of claim 8, wherein the said feature is at least one orifice.

10. The device of claim 1, wherein the said agitation means is manually operated.

11. The device of claim 10, wherein the said manually operated agitation means is a flexible elastomer bulb.

12. The device of claim 11, wherein the said elastomer bulb is also a handle for the device.

13. The device of claim 1, wherein the said agitation means is a liquid pump.

14. The device of claim 1, wherein the said agitation means is a pneumatic pump.

15. The device of claim 1, wherein the said agitation means is powered via stored energy.

16. The device of claim 14, wherein the said manually operated agitation means is a bellows.

17. The device of claim 1, wherein the said elongated container has at least one substantially flat feature configured for resting the device on a surface.

18. A device for cleaning an animal's paw, comprising:
An elongated container adapted to retain a liquid, having a sidewall with an open upper end; and
an enclosed lower end; and
a means to produce turbulence of said liquid.

19. The device of claim 18, wherein the said means to produce turbulence is a liquid pump.

20. The device of claim 18, wherein the said means to produce turbulence is a pneumatic pump.

21. The device of claim 18, wherein the said entry point is adapted to receive an elastic squeegee that substantially covers the opening of said container.

22. The device of claim 21, wherein the said elastic squeegee has accordion folds.

23. The device of claim 22, wherein the said accordion folds extend axially inward forming a conical shape.

24. A device for cleaning an animal's paw, comprising:
An elongated container adapted to retain a liquid, having a sidewall with an open upper end; and
an enclosed lower end; and
the said container is adapted to removably secure a drying feature.

25. The device of claim 24, wherein the drying feature is absorbent material.
